(19) United States
(12) Patent Application Publication
(10) Pub. No.: US 2019/0057368 A1
(43) Pub. Date: Feb. 21, 2019

(54) Electronically warehousing items of stored value

(71) Applicant: Interact Ventures, Richardson, TX (US)

(72) Inventor: Deepak Jain, Richardson, TX (US)

(21) Appl. No.: 15/999,384

(22) Filed: Aug. 20, 2018

Related U.S. Application Data
(60) Provisional application No. 62/547,540, filed on Aug. 18, 2017.

(51) Int. Cl. G06Q 20/20; G06Q 20/04; G06Q 20/32; G06Q 20/36; G06Q 20/18; G06Q 10/08

(52) U.S. Cl. CPC G06Q 20/209; G06Q 20/0457; G06Q 20/322; G06Q 10/08; G06Q 20/36; G06Q 20/18; G06Q 20/3274

(57) ABSTRACT

In some implementations, a method includes receiving a public display identifier (PDI) from a purchaser. An item of value assigned to the PDI is determined. Information identifying a proposed item of value in exchanged for the item of value assigned to the PDI is received. The exchange is authorized based on one or more parameters. The authorization is transmitted to an electronic warehouse containing inventory of the item of value assigned to the PDI. The secret data for the item of value assigned to the PDI is received. The secret data is dispensed to the purchaser.

### TECHNICAL FIELD

This invention relates to network communication and, more particularly, to electronically warehousing items of stored value.

### BACKGROUND

Items of value (e.g., prepaid cards) are popular prepayment mechanisms today. Typically, an item of value is purchased from a merchant or an associated retailer (e.g., grocery store, electronic store). Items of value are purchased with funds such cash, check, credit card, or other transactions. Using the items of value, individuals can redeem the goods or services from the merchant. In some cases, merchants can use the items of value to provide consumers with rebates, discounts, in-store credit, and other promotions.

### SUMMARY

In some implementations, a method includes receiving a public display identifier (PDI) from a purchaser. An item of value assigned to the PDI is determined. Information identifying a proposed item of value in exchanged for the item of value assigned to the PDI is received. The exchange is authorized based on one or more parameters. The authorization is transmitted to an electronic warehouse containing inventory of the item of value assigned to the PDI. The inventory can be managed on Blockchain or a Cloud Database. The secret data for the item of value assigned to the PDI is received. The secret data is dispensed to the purchaser. The secret data dispensed to the purchaser could be a key for a digital wallet or cryptocurrency wallet.

### DESCRIPTION OF DRAWINGS

FIG. 1 is an example system for communicating using a transaction network.

FIG. 2A-C are example receipts identifying information for redeeming goods or services.

FIG. 3 is a flow chart illustrating an example method for distributing prepaid items of value.

FIG. 4 is a flow chart illustrating an example method for distributing items of value acquired in real time.

FIG. 5 is an example kiosk including a point-of-sale device and a dispensing system.

Like reference symbols in the various drawings indicate like elements.

### DETAILED DESCRIPTION

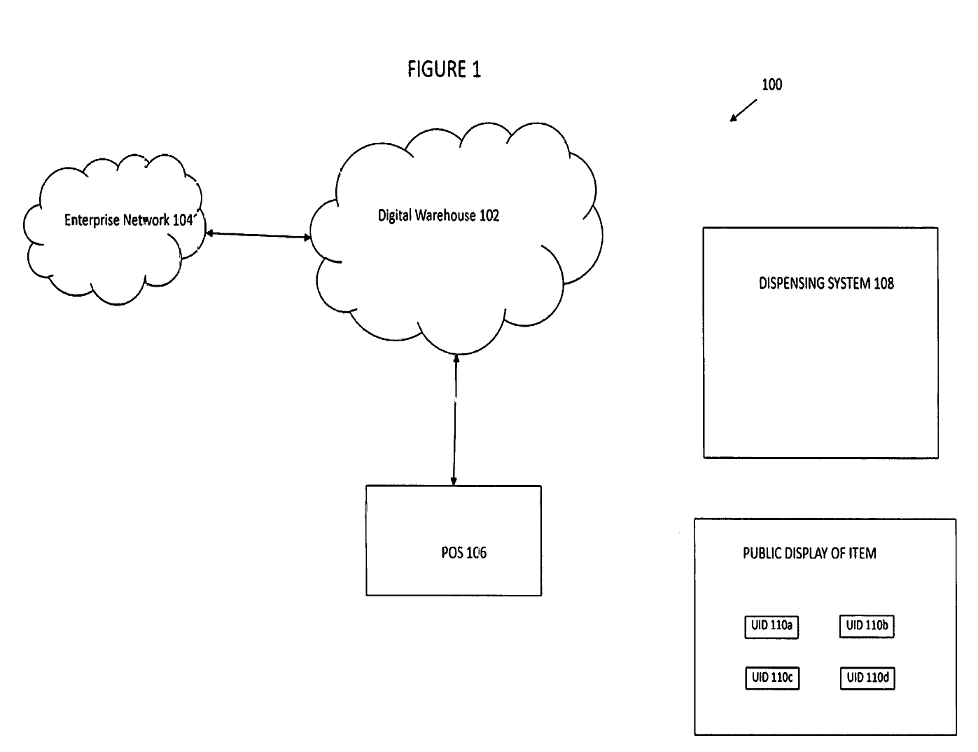

FIG. 1 is an example system 100 for electronically warehousing items of value that can be purchased using another item of value. For example, the system 100 may electronically warehouse movie tickets that can be purchased using, for example a prepaid card. Items of value can include electronic items that represent goods or services for purchase. For example, items of values include prepaid cards, gift cards, movie tickets, vouchers, coupons, digital music, club membership, vacation packages, insurance membership, cryptocurrency like tokens or coins and/or a combination of the aforementioned items and others. In some implementations, the system 100 can perform one or more of the following: electronically store multiple items of value that can be purchased in exchange for other items of value; receive request to exchange items of values from a point of sale (POS) device; authorize the exchange based on one or more parameters; transmit instructions to the POS device to include proof of the authorized exchange; printing receipt including proof of authorized exchange. As a result of electronically warehousing items of value, the system 100 may provide one or more of the following advantages: eliminate the requirement of physical inventory of items of value being stored in the same premise as the merchant; prevent loss from theft of items of value as they are not unlocked unless the merchant receives value from the purchaser; real-time delivery of the items of value from the merchant ensures no waiting time for the purchaser; allows inventory to be extended in real-time by eliminating situations where items go out of stock and need time to be replenished; reduce costs of the public displays as they don't need to be secured; increase space in a retail environment by moving items of value that can be electronically fulfilled (e.g., gift cards, event tickets, vouchers, coupons, music, movie or cryptocurrency) to be fulfilled by an onsite dispensing system instead of being stocked on shelves; improve overall user experience and efficiency of the retail environment; facilitate a move from physical to electronic fulfillment of items of value for a enterprise; facilitate a transition from housing inventory to real-time acquisition of items of value thereby improving cash flow; facilitate a transition in reverse from real-time acquisition of certain type of items into prepaid inventory in order to increase sales and profit margins; and others.

As illustrated, the system 100 includes a digital warehouse 102 communicably coupled to an enterprise network 104 and a POS device 106. The digital warehouse 102 can include any combination of software, hardware, and firmware configured to store and distribute items of value. For example the digital warehouse 102 can be a system implemented on a private Blockchain. For example, the digital warehouse 102 can distribute items of value received from, for example, the enterprise network 104, and distribute the items of value through, for example, the POS device 106. In some implementations, a member of the general public can purchase, from the digital warehouse 102, multiple items of value in exchange for another item of equal value, which can be defined by the owner of item of value (e.g., enterprise). Each item of value can contain a secret number that is used to provide goods or services in exchange of receiving the value from the purchaser. In some cases, each item of value can also contain a unique identifier (UID) for tracking and accounting purposes. In some implementations, the digital warehouse 102 can be owned by the wholesaler interested in safely selling and/or dispensing one or many items of value to the general public (group of purchasers). In some implementations the digital warehouse can be decentralized on the Blockchain with each node serving as a representative of different owners of the digital inventory contributed to the warehouse. The digital warehouse 102 can be secure and not directly available to the general public. In some implementations, the digital warehouse 102 can have protections in place to ensure that each item of value can only be made available to the POS device 106 belonging to the seller upon the proper receipt of value from the purchaser.

The digital warehouse 102 may acquire the items of value and its corresponding data from a system to replenish inventory (SRI). In some implementations, the SRI is responsible for ensuring that the items of value are available to the digital warehouse 102 as per the requirement of the digital-warehouse owner. In general, the SRI manages the acquisition and availability of the items of value in one or more of the following implementations: in bulk from the enterprise for a negotiated wholesale cost; in bulk from a distributor negotiate a discount over the proposed value; executing processes in real-time by connecting to a 3rd party e-commerce platform or processor connected to the enterprise or the distributor; in near real-time using a bulk ordering mechanism; and others. In some implementations, the SRI can be operated by a 3rd party or managed by the digital-warehouse owner. The SRI can be responsible for negotiating business terms for the acquisition of the items of values from enterprises. In some implementations, the SRI can be implemented as another private Blockchain interfacing to the digital warehouse. The SRI can also make available new items of value from newer goods or services from time to time. The SRI is also capable of performing other operations with the items of value such one or more of the following: restoring an item previously sold and dispensed back into the inventory should the POS device 106 authorize a return; changing the value of the items of value if requested by the POS device 106 and authorized by the enterprise or the processor; creating on demand combinations of items and new items of value in real-time based on requests received from the POS device 106 or system administrators; marking items out of stock; managing discounts and special sales on items of value according to different rules and parameters set by the enterprise; and others

The enterprise network 104 is a network associated with an enterprise that provide one or more items of value. The enterprise may comprise a corporate or business entity, a government body, a non-profit institution, or any other organization. In some implementations, the enterprise manages the telecommunications and network services accessed using the enterprise network 104. The enterprise network 104 may communicate, for example, Internet Protocol (IP) packets, Frame Relay frames, Asynchronous Transfer Mode (ATM) cells, voice, video, data, and other suitable information between network addresses. In addition, while enterprise network 104 is illustrated as a single network, the enterprise network 104 may comprise a plurality of networks. Also, the enterprise network 104 may comprise different types of networks compatible with different protocols without departing from the scope of this disclosure.

The POS device 106 can include any software, hardware, and/or firmware that receive account information for executing a transaction with the digital warehouse 102. For example, the POS device 106 may be an electronic cash register capable of receiving information identifying one or more items of value in exchange for one or more different items of value. The information may include a unique identifier (UID) of the requested items of value, verification information, check number, routing number, account number, transaction amount, time, driver's license number, merchant ID, merchant parameters, credit-card number, debit-card number, digital signature, membership number and/or other information. In some implementations, the information may be encrypted. The POS device 106 can be a cash register at a store, a shopping cart in an e-commerce website, a mobile application, an unmanned kiosk, a vending machine, a handheld payment acceptance device, a vending machine, a tablet or other device without departing from the scope of the disclosure.

In some implementations, the POS device 106 can receive a public display identified (PDI) from the purchaser and determines the one or more items of value to be transferred to the purchaser and the value needed to be received from the purchaser for the transfer to be authorized. The POS device 106 can accept forms of value aside from cash if recognized by the seller and having a sufficient value to make the item available to the purchaser. Based on the determination, the POS device 106 can receive the value from the purchaser along with verifiable proof that the value from the purchaser has been received (and is available to the seller). The POS device 106 can securely communicate, to the electronic warehouse 102, the identification information for the item(s) identified by the PDI and authorization to transfer the item from the electronic warehouse 102 to the purchaser using, for example, a dispensing system (DIS) 108. In some implementations, the POS device 106 can print the item of value on a receipt or provide a merchant code that is used to redeem the item of value directly from the merchant. The POS device 106 can provide the purchaser a confirmation (e.g., unique and verifiable) that the item is now available to be dispensed from the DIS 108. Once provided to the purchaser, the POS device 106 can communicate back to the electronic warehouse 102 that the confirmation has been provided to the purchaser and the transaction has been completed successfully. In some instances, the POS device 106 can record the transaction with all relevant details in a ledger. Based on the recorded transactions, the POS device 106 can, in some implementations, reverse transactions should such a reversal be authorized by the seller and the enterprise. If such reversal takes place, the items are safely restored back into the electronic warehouse 102 and the PDI if so determined as qualified for being resold to another purchaser.

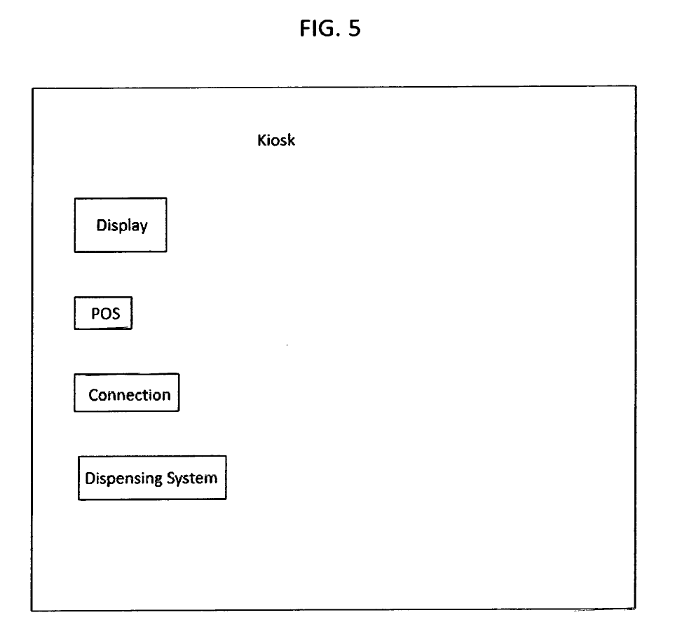

In some implementations, the system 100 includes a dispensing system (DIS) 108 for distributing items of value to purchasers. The DIS 108 can be responsible for ensuring that the holder of the confirmation number is capable of redeeming the value pertaining to the item of value that has been transacted at the POS device 106. The DIS 108 can connect to the electronic warehouse 102 in order to securely receive the secured data belonging to the item(s) and make the secure data available to the purchaser. In some implementations, the DIS 108 can perform one or more of the following: print actual data in clear on a receipt; print actual data in clear on a card; print actual data on the PDI itself, print a Quick Response (QR) code on a receipt or card where the QR code represents the secure data in such a way that only the enterprise/merchant that is owing the product advertised on the PDI can read the QR code and reveal the secure data to the purchaser; print another type of secured code different from a QR code; use an electronic form of communication to the purchaser (e.g., an email, SMS, MMS, Whatsapp message, Chat message, NFC transmission to user's mobile phone) either in addition to printing or in lieu of printing; and others. The DSI 108 can be a standalone device separate from the POS device 106 such as, for example, an unmanned kiosk with a camera or keyboard or another scanning device to read the confirmation number. The DSI 108 can be other devices without departing from the scope of the disclosure such as a printer connected to the POS, electronic software connected to the POS device 106 and the cloud; a messaging platform connected to the POS device 106; a person manually exchanging the confirmation code with the item secret data; or others. While the POS device 106 and the DIS 108 are illustrated as separate device in FIG. 1, the POS device 106 and the DIS 108 may be combined in a single device such as the kiosk illustrated in FIG. 5.

In some implementations, the secured data can be delivered directly to the user's mobile phone number where it is received by a digital wallet or a cryptocurrency wallet. In this case, the secured data might contain the data encrypted by the private key of the digital wallet or cryptocurrency wallet. When the secured data is received by the cryptocurrency wallet or digital wallet and is decrypted successfully, it can then load the item of value into the user's digital wallet. In this case, the item of value might include a cryptocurrency or token or coin that is capable of being traded on the public markets

In some implementations, the system 100 includes a public display of items (PDI) 110 at the merchant. In general, the PDI 110 is a public display that makes it known to the general public the availability of the SKU for purchase. The PDI 110 can be of various forms such as, for example, a website, a kiosk in a store, a shelf with J-hooks with physical items hanging as a marker for the item of value, a banner with a QR code offering the item of value for a discount, a sign in a warehouse advertising the item of value, or other marketing mechanism to attract members of the general public to purchase one or multiple items of the item of value. Typically, the PDI 110 has no value. In these instances, even if the PDI 110 is stolen (in whole or in part), there is no mechanism for the PDI 110 to unveil the secured data in the item of value. The PDI 110 has identifying information (e.g., a number, barcode or code) to identify the item of value or an individual item in the item of value or a collection of items from one or more items of value. The PDI 110 can also have information on the amount of value contained should a purchaser decide to purchase it as well as the value that the purchaser must make available for the item to be transferred from the seller to the purchaser.

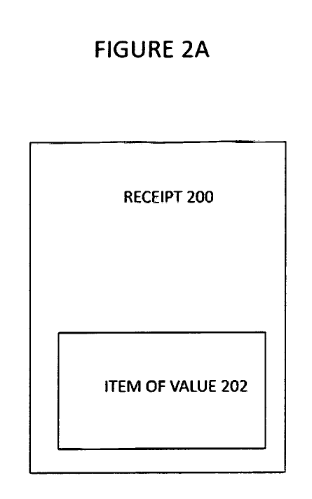

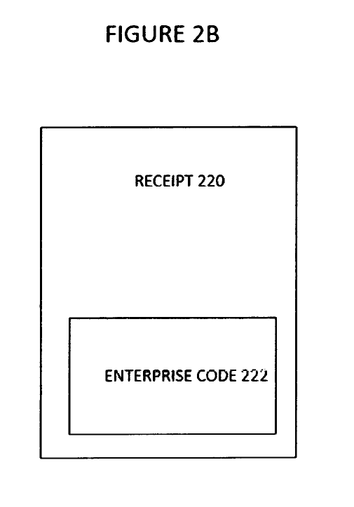

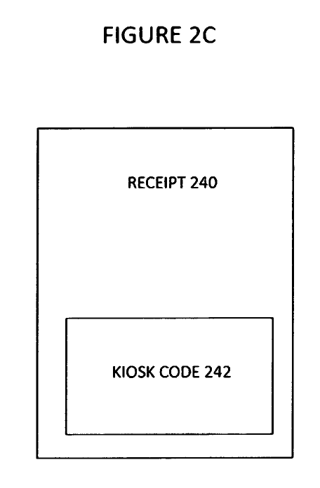

FIGS. 2A-C illustrate example receipts 200, 220, and 240 in accordance with some implementations of the present disclosure. For example, the POS device 106 of FIG. 1 can print one of the receipts 200, 220, and 240 in exchange for an item of value approved by the enterprise to the purchased item of value. In FIG. 2A, the receipt 200 includes the item of value 202 printed on the receipt. In FIG. 2B, the receipt 220 includes an enterprise code 222 printed on the receipt. In these instances, the purchaser can submit the enterprise code 222 to the enterprise and receive the item of value in return. In FIG. 2C, the receipt 240 includes a kiosk code 242. In these instances, the purchaser can submit the code to, for example, the DIS 108 of FIG. 1, which will, in turn, dispense an item of value to the purchaser.

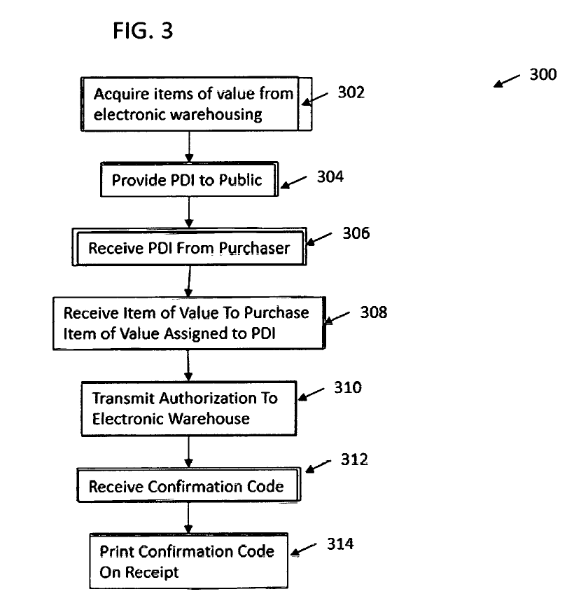

FIG. 3 is a flowchart illustrating an example method 300 for distributing prepaid inventory in accordance with some implementations of the present disclosure. For clarity of presentation, the description that follows generally describes method 300 in the context of the other figures in this description. For example, method 300 can be performed by the POS device 106 described in FIG. 1. However, it will be understood that method 300 may be performed, for example, by any suitable system, environment, software, and hardware, or a combination of systems, environments, software, and hardware, as appropriate. In some implementations, various steps of method 300 can be run in parallel, in combination, in loops, or in any order. In some implementations, the steps of method 300 can be run automatically.

Method 300 begins at step 302 where a plurality of items of values acquired from electronic warehousing. For example, the POS device 106 may acquire the items or values or information identifying the items of value from the electronic warehouse 102. At step 304 and 306, a purchaser provides a PDI assigned to one or more items of value. In the example, the purchaser can provide the POS device 106 with the PDI. Next, at step 308, the purchaser provides an item of value in exchange for the one or more items of value assigned to the PDI. As for the example, the purchaser can provide, for example, cash or a prepaid card to the POS device 106. Authorization for the exchange is transmitted to the electronic warehouse at step 310. In the example, the POS device 106 may initially determine whether the offered item of value is an acceptable exchange for the one or more items of value assigned to the PDI. At step 312, a confirmation code is received from the electronic warehouse and printed on a receipt. In the example, the POS device 106 prints the confirmation code on a receipt, which can be used to acquire the item of value from, for example, a kiosk.

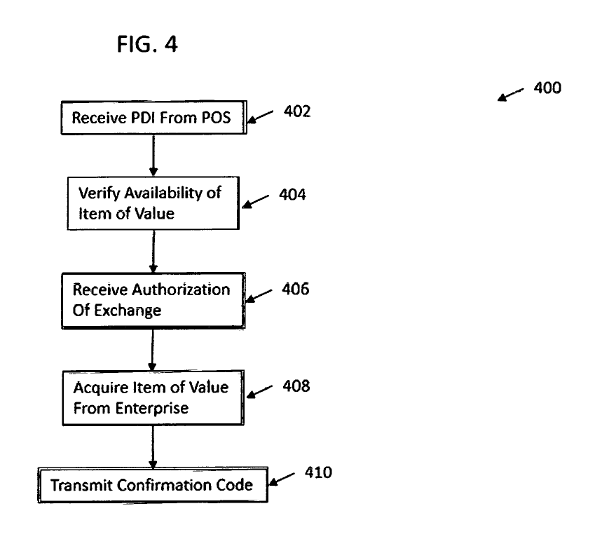

FIG. 4 is a flowchart illustrating an example method 400 for acquiring inventory in real time in accordance with some implementations of the present disclosure. For clarity of presentation, the description that follows generally describes method 400 in the context of the other figures in this description. For example, method 400 can be performed by the electronic warehouse 102 described in FIG. 1. However, it will be understood that method 400 may be performed, for example, by any suitable system, environment, software, and hardware, or a combination of systems, environments, software, and hardware, as appropriate. In some implementations, various steps of method 400 can be run in parallel, in combination, in loops, or in any order. In some implementations, the steps of method 400 can be run automatically.

Method 400 begins at step 420 where a PDI is received from a POS. For example, the electronic warehouse 102 may receive a PDI from the POS device 106. At step 404, availability of the item of value assigned to the PDI is determined. In the example, the electronic warehouse 102 may transmit a request to the SRI to determine the availability. Next, at step 406, authorization of the exchange is received from the POS. As for the example, the POS device 106 transmit authorization for the exchange to the electronic warehouse 102. In response, the item of value is acquired at step 408. In the example, the electronic warehouse 102 can have the SRI acquire the item of value from the enterprise network 104. At step 410, the confirmation code is transmitted to the POS.

What is claimed:

1. An electronic warehouse, comprising:
memory storing information identifying:
encrypted digital codes representing items of value;
publicly displayable identifier (PDI) representing each of the digital codes;
a connection to a Point of Sale system that accepts payment from a purchaser and delivers an item of value from the secret inventory to a purchaser;
a connection to an electronic system to replenish the secret inventory (SRI).

2. A Point of Sale system, comprising:
a payment acceptance system to accept payment for an item of value from a purchaser;
a connection to the electronic warehouse to send the PDI for an item of value being purchased and receive the corresponding secret data;
a decryption system to decrypt the secret data for the item of value;
a connection to a dispensing system to make the secret data for the purchased item available to the purchases.

3. A system to replenish inventory, comprising:
a mechanism to detect when the number of unsold items of value are below a threshold and
a real-time connection with providers of the item of value to purchase and stock additional items of value.

4. A method, comprising:
receiving a public display identifier (PDI) from a purchaser;
determining an item of value assigned to the PDI;
receive information identifying a proposed item of value in exchanged for the item of value assigned to the PDI;
authorizing the exchange based on one or more parameters;
transmitting the authorization to an electronic warehouse containing inventory of the item of value assigned to the PDI;
receiving the secret data for the item of value assigned to the PDI; and
dispensing the secret data to the purchaser.

5. The method of claim 4, wherein the proposed item of value is at least one of gift card, a prepaid card, cryptocurrency coin or token, a pack of movie tickets or a pack of gift cards.

6. The method of claim 4, wherein the one or more parameters include one or more rules and values defined by an enterprise that sells the item of value assigned to the PDI.

7. The method of claim 4, wherein the dispensing system is a printer configured to print the secret data assigned to the PDI on the receipt.

8. The method of claim 4, wherein the dispensing system comprises of a mechanism to receive the PDI through an input slot and a printer configured to print the secret data assigned to the PDI on the surface of the PDI.

9. The method of claim 4, wherein the dispensing system comprises of a software configured to securely send the secret data assigned to the PDI to the purchaser electronically using an email or a text message or a chat message.

10. The method of claims 4 and 9, further comprising of the secret data delivered electronically to a user's digital wallet or cryptocurrency wallet and encrypted by a user's private key.

11. The method of claim 4, wherein the dispensing system comprises of a displaying the secret data assigned to the PDI on a mobile app on the user's smartphone.

12. The method of claim 4, wherein the dispensing system comprises of a software configured to electronically communicate the secret data to a handheld device of the purchaser using Near Field Communication, Bluetooth or similar radio communication interfaces.

13. The method of claim 4, where the secret data is a QR code, a 1D/2D barcode, an image, a confirmation code, a coded pattern, an encrypted packet containing item of value meant for a digital wallet or cryptocurrency wallet, or text.

14. The method of claim 4, wherein if a item assigned to the PDI is not present in the inventory of the electronic warehouse, the SRI is first used in real-time to acquire additional units of the item of value to replenish the inventory, and then proceeding with the remaining steps to complete the method.

15. The method of claim 13, wherein methods of payment comprise of credit card, debit card, prepaid card, gift card, cash, check, digital wallet on a smartphone, smart watch, cryptocurrency, email address or phone number identifying a card on file in the cloud or an electronic wallet or a cryptocurrency wallet.

16. An unmanned Kiosk or Vending Machine system, comprising:
an electronic display such as a tablet displaying on the screen all the PDIs available for purchase in a graphical user interface;
a Point-of-Sale system capable of accepting methods of payments from the user to pay for the items of value assigned to the PDI;
a connection to the Electronic Warehouse; and
a dispensing system configured to dispense secret data assigned to the PDI.
